(19) United States
(12) Patent Application Publication
(10) Pub. No.: US 2006/0272588 A1
(43) Pub. Date: Dec. 7, 2006

(54) Pet bowl and box for nutritional ice

(76) Inventor: David Decroix, Enghien (BE)

Correspondence Address: NOTARO AND MICHALOS, 100 DUTCH HILL ROAD, SUITE 110, ORANGEBURG, NY, 10962-2100, US

(21) Appl. No.: 11/334,900

(22) Filed: Jan. 19, 2006

(30) Foreign Application Priority Data
Jun. 1, 2005 (EM) 81559

(51) Int. Cl. A01K 5/01

(52) U.S. Cl. 119/61.5

(57) ABSTRACT

A container assembly for bone-shaped pet products has a bone-shaped a container, a bone-shaped lid for closing the container, and a bone-shaped bowl sized and shaped for being received in the container, the bowl having a bone-shaped recess adapted for containing one bone-shaped pet product to be served to a pet. The separate container with lid, and bowl are also part of the invention.

### FIELD AND BACKGROUND OF THE INVENTION

The present invention relates generally to the field of plastic containers, and in particular, to a new and useful bone-shaped bowl and container for a bone shaped nutritional product for pets, in particular, for dogs.

Plastic containers with lids are know in various shaped and sizes, as are feeding bowls for pets.

The present invention is a container and bowl combination, as well as the container and bowl separately, which each have a unique appearance and function to contain and serve a bone-shaped nutritional and preferably frozen product for pets in general, and for dogs, in particular.

### SUMMARY OF THE INVENTION

It is an object of the present invention to provide a container assembly for bone-shaped pet products having a bone-shaped a container, a bone-shaped lid for closing the container, and a bone-shaped bowl sized and shaped for being received in the container, the bowl having a bone-shaped recess adapted for containing one bone-shaped pet product to be served to a pet. The separate container with lid, and the bowl, are also part of the invention.

In greater detail, the invention is a container assembly for bone-shaped pet products, comprising: a container having a sidewall with a top rim, and a bottom wall connected to the sidewall, the sidewall having a pair of sides and a pair of ends connected between the sides for forming a closed loop around an interior of the container, the interior being adapted for containing at least one bone-shaped pet product, and bottom wall having a pair of side edges and a part of end edges with the edges of the bottom wall being connected to the respective sides and ends of the sidewall for closing a lower end of the interior, each of the sides and ends of the sidewall and each of the side and end edges of the bottom wall having an inwardly concave contour with respect to the interior and the top rim having side and end edges that each having an inwardly concave contour with respect to the interior so that the interior of the container has an appearance of a bone in top plan view; a lid having a substantially flat top surface and a lower peripheral channel for receiving the top rim of the container for closing an upper end of the interior, the lid having a pair of side edges and a pair of end edges that each having an inwardly concave contour with respect to the interior when the lid closes the upper end of the interior, so that the lid also has an appearance of a bone in top plan view; and a bowl which is sized and shaped for being received in the interior of the container, the bowl having a recess that is adapted for containing one bone-shaped pet product to be served to a pet, the bowl having a substantially flat top wall containing the recess with a perimeter around the recess, the bowl including a sidewall connected to the top wall and having a pair of sides and a pair of ends connected between the sides for forming a closed loop around the top wall, the recess having an interior sidewall with a pair of sides and a pair of ends connected between the sides for forming a closed loop around an interior of the recess, the sides and ends of the sidewalls of the recess and bowl having an inwardly concave contour so that the recess and the top wall have an appearance of a bone in top plan view.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which a preferred embodiment of the invention is illustrated.

### BRIEF DESCRIPTION OF THE DRAWINGS

In the drawings:

FIG. 1 is a top, front, left perspective and exploded view of the various parts of the container assembly for bone-shaped pet products according to the present invention;

FIG. 2 is a top, rear, right perspective view of the container and lid of the assembly;

FIG. 3 is a top, rear, right perspective view of the bowl of the assembly;

FIG. 4 is a front elevational view of the container and lid of the assembly;

FIG. 5 is a top, rear, right perspective view of the container of the assembly; and

FIG. 6 is a top plan view of the container.

### DESCRIPTION OF THE PREFERRED EMBODIMENTS

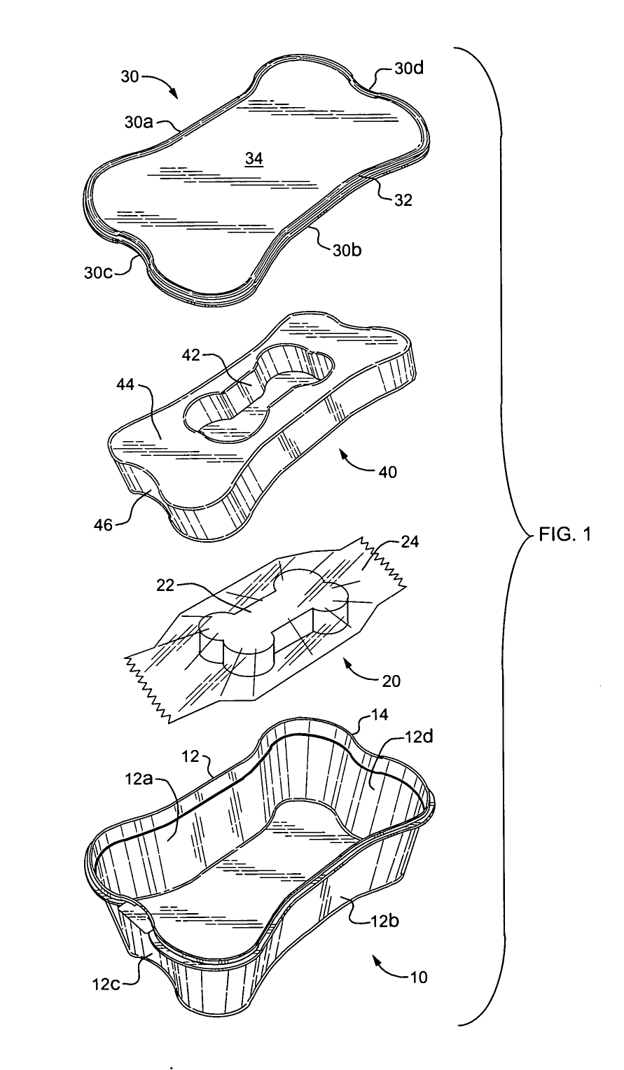

Referring now to the drawings, in which like reference numerals are used to refer to the same or similar elements, FIG. 1 shows a container assembly for bone-shaped pet products, comprising a container 10 having a sidewall 12 with a top rim 14, and a bottom wall 16 connected to the sidewall 12. The sidewall 12 has a pair of sides 12a and 12b which can form the front and rear of the container, for example, and a pair of ends 12c and 12d, connected between the sides for forming the sidewall into a closed loop around an interior or inner volume of the container.

The interior is adapted for containing at least one bone-shaped pet product 20, which is advantageously a frozen bone-shaped food product for pets at 22, wrapped in appropriate plastic or other wrapping 24.

The bottom wall 16 of container 10 has a pair of side edges and a pair of end edges with the edges of the bottom wall being connected to the respective sides 12a, 12b, and ends 12c, 12d, of the sidewall 12 for closing the lower end of the interior space. Each of the sides and ends of the sidewall and each of the side and end edges of the bottom wall having an inwardly concave contour as shown in the drawings, with respect to the interior. Each of the sides and ends of the sidewall and each of the side and end edges of the bottom wall have opposite enlarged ends that extend outwardly of the interior, as also shown. As a result the sidewall 12 and bottom wall 16 each have a distinctive bone-shape in top plan view.

The top rim 14 also has side and end edges that each having an inwardly concave contour with enlarged outwardly extending ends with respect to the interior, so that the top opening into the interior of the container 10 also has the appearance of a bone in top plan view.

A lid 30 has a ridge 32 with downwardly facing groove or peripheral channel around its perimeter for engaging the rim 14 to close the top opening of container 10. Lid 30 also has a substantially flat top surface 34 bounded by the ridge. The lower peripheral channel receives the top rim 14 of the container in a press-fit, for closing the upper end or opening of the interior. The flat top surface is lower than the ridge and thus forms a flat valley across most of the area of the lid in top plan view.

The lid has a pair of side edges 30a and 30b and a pair of end edges 30c and 30d that each having an inwardly concave contour and enlarged ends with respect to the interior, when the lid 30 closes the upper end of the container 10, so that the lid also has the appearance of a bone in top plan view.

The assembly also includes a bone-shaped bowl 40 which is sized and shaped for being closely received in the interior of the container 10, the bowl having a bone-shaped recess 42 that is adapted for containing one bone-shaped pet food product 22 to be served to a pet, e.g. a dog. The bowl has a substantially flat top wall 44 containing the recess 42 with a perimeter around the recess, the bowl including a sidewall 46 connected to the top wall and having a pair of sides and a pair of ends connected between the sides for forming a closed loop around the top wall.

The recess has an interior sidewall with a pair of sides and a pair of ends connected between the sides for forming a closed loop around an interior of the recess, the sides and ends of the sidewalls of the recess and bowl having an inwardly concave contour with enlarged substantially circular ends so that the recess has a pair of such enlarged circular regions at each end. The recess and the top wall 44 thus also have the appearance of a bone in top plan view. The sidewall 46 also has sides and ends with a similar inwardly concave contours with enlarged ends so that the sidewall 46 of the bowl 40 also has the appearance of a bone in top plan view.

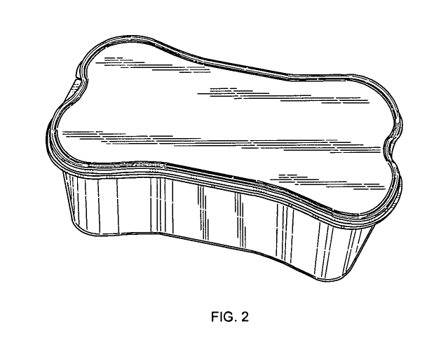

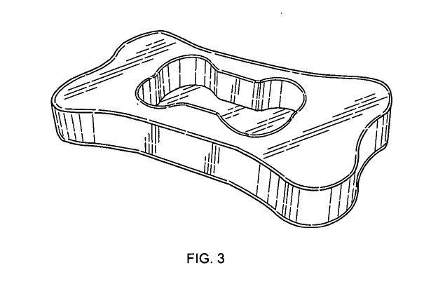

FIG. 2 shows the container 10 with its lid 30 engaged to close the container and FIG. 3 is another view of the bone-shaped bowl with bone-shaped recesses for closely receiving one bone-shaped and preferably frozen pet food product 22.

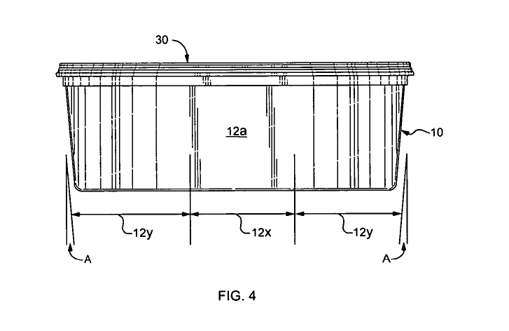

With reference to FIGS. 4 to 6 the sidewall 12 tapers from its larger top open end to its bottom wall at an angle A of about 4 degrees to the vertical or preferably about 2 to 10 degrees from the vertical.

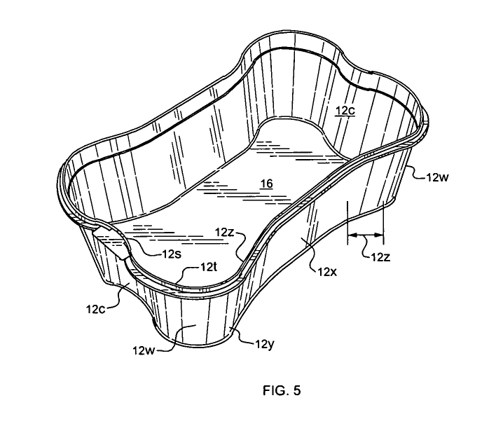

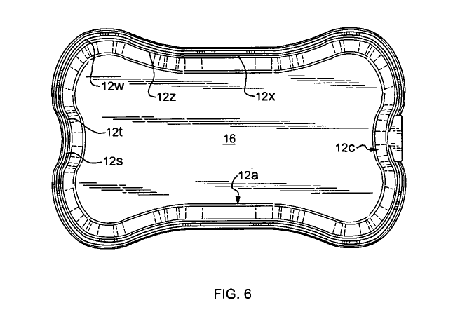

Sides 12a and 12b and ends 12c and 12d, are identical to each other so that only one will be describer further in detail. Side 12a has a central substantially flat area 12x of about ⅓ (preferably from ¼ to ⅔) of the overall length of the container 10 from end to end. Side. 12a also has opposite equal end areas 12y, 12y on opposite sides of the central area 12x which make up the remainder of the length of the side. Each end area 12y is further divided into a substantially flat and outwardly extending area 12z as best shown in FIGS. 5 and 6, followed by a radius area 12w that takes the side 12a over to each end 12c and 12d.

Each end 12c and 12d has a central concave area 12s with opposite, slightly flattened areas 12t that transition into the radius areas 12w at each corner of the container sidewall 12.

The perimeter of the lid 30 at ridge 32 and the rim 14 of the container 10 also have these respective areas.

While a specific embodiment of the invention has been shown and described in detail to illustrate the application of the principles of the invention, it will be understood that the invention may be embodied otherwise without departing from such principles.

What is claimed is:

1. A container assembly for bone-shaped pet products, comprising:
a container having a sidewall with a top rim, and a bottom wall connected to the sidewall, the sidewall having a pair of sides and a pair of ends connected between the sides for forming a closed loop around an interior of the container, the interior being adapted for containing at least one bone-shaped pet product, and bottom wall having a pair of side edges and a part of end edges with the edges of the bottom wall being connected to the respective sides and ends of the sidewall for closing a lower end of the interior, each of the sides and ends of the sidewall and each of the side and end edges of the bottom wall having an inwardly concave contour with respect to the interior and the top rim having side and end edges that each having an inwardly concave contour with respect to the interior so that the interior of the container has an appearance of a bone in top plan view;
a lid having a substantially flat top surface and a lower peripheral channel for receiving the top rim of the container for closing an upper end of the interior, the lid having a pair of side edges and a pair of end edges that each having an inwardly concave contour with respect to the interior when the lid closes the upper end of the interior, so that the lid also has an appearance of a bone in top plan view; and
a bowl which is sized and shaped for being received in the interior of the container, the bowl having a recess that is adapted for containing one bone-shaped pet product to be served to a pet, the bowl having a substantially flat top wall containing the recess with a perimeter around the recess, the bowl including a sidewall connected to the top wall and having a pair of sides and a pair of ends connected between the sides for forming a closed loop around the top wall, the recess having an interior sidewall with a pair of sides and a pair of ends connected between the sides for forming a closed loop around an interior of the recess, the sides and ends of the sidewalls of the recess and bowl having an inwardly concave contour so that the recess and the top wall have an appearance of a bone in top plan view.

2. The assembly of claim 1, wherein the container sidewall tapers from the top to the bottom wall.

3. The assembly of claim 2, wherein each side of the container sidewall has a central substantially flat area of about ¼ to ⅔ of an over all length of the container from end to end, and opposite equal end areas on opposite sides of the central area which extend outwardly of the interior.

4. The assembly of claim 3, wherein each end area includes a flattened area followed by a radius area that extends to a respective end of the sidewall.

5. The assembly of claim 4, wherein each end of the container sidewall includes a central concave area with opposite, slightly flattened areas that transition to the radius areas.

6. A container for a bone-shaped bowl, comprising:
a sidewall with a top rim;
a bottom wall connected to the sidewall;
the sidewall having a pair of sides and a pair of ends connected between the sides for forming a closed loop around an interior of the container, the interior being adapted for containing at least one bone-shaped bowl; and
bottom wall having a pair of side edges and a part of end edges with the edges of the bottom wall being connected to the respective sides and ends of the sidewall for closing a lower end of the interior, each of the sides and ends of the sidewall and each of the side and end edges of the bottom wall having an inwardly concave contour with respect to the interior and the top rim having side and end edges that each having an inwardly concave contour with respect to the interior so that the interior of the container has an appearance of a bone in top plan view; and
a lid having a substantially flat top surface and a lower peripheral channel for receiving the top rim of the container for closing an upper end of the interior, the lid having a pair of side edges and a pair of end edges that each having an inwardly concave contour with respect to the interior when the lid closes the upper end of the interior, so that the lid also has an appearance of a bone in top plan view.

7. The container of claim 6, wherein the container sidewall tapers from the top to the bottom wall.

8. The container of claim 7, wherein each side of the container sidewall has a central substantially flat area of about ¼ to ⅔ of an over all length of the container from end to end, and opposite equal end areas on opposite sides of the central area which extend outwardly of the interior.

9. The container of claim 8, wherein, each end area includes a flattened area followed by a radius area that extends to a respective end of the sidewall.

10. The container of claim 9, wherein each end of the container sidewall includes a central concave area with opposite, slightly flattened areas that transition to the radius areas.

11. A bowl for a bone-shaped pet product, comprising:
a top wall having a recess that is adapted for containing one bone-shaped pet product to be served to a pet;
the top wall being substantially flat for containing the recess with a perimeter around the recess; and
a sidewall connected to the top wall and having a pair of sides and a pair of ends connected between the sides for forming a closed loop around the top wall;
the recess having an interior sidewall with a pair of sides and a pair of ends connected between the sides for forming a closed loop around an interior of the recess, the sides and ends of the sidewalls of the recess and bowl having an inwardly concave contour so that the recess and the top wall have an appearance of a bone in top plan view.

12. The bowl of claim 11, wherein each side of the bowl sidewall has a central substantially flat area of about ¼ to ⅔ of an over all length of the container from end to end, and opposite equal end areas on opposite sides of the central area which extend outwardly of the interior.

13. The bowl of claim 12, wherein each end area includes a flattened area followed by a radius area that extends to a respective end of the sidewall.

14. The bowl of claim 13, wherein each end of the bowl sidewall includes a central concave area with opposite, slightly flattened areas that transition to the radius areas.
